(19) United States
(12) Patent Application Publication
(10) Pub. No.: US 2007/0235124 A1
(43) Pub. Date: Oct. 11, 2007

(54) Edging Strip For An Upholstered Furniture Article

(75) Inventor: Sanford L. Van Dyke, Conover, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hickory Springs Manufacturing Company, Hickory, NC (US)

(21) Appl. No.: 11/278,234

(22) Filed: Mar. 31, 2006

(51) Int. Cl. B29C 53/00

(52) U.S. Cl. 156/217; 428/304.4

(57) ABSTRACT

An edging strip for softening a rigid edge of a framing element in an upholstered furniture article. The edging strip includes a core and a securing layer. The form core may be formed in at least part from a foam material, such as recycled polyethylene. The securing layer may be formed in at least part from a nonwoven cloth material. The nonwoven cloth material is wrapped around the foam core such that foam core is encapsulated by the cloth and the cloth forms a tab for securing the foam core to the framing element. The tab may be defined by a first end and a second end of the cloth that are bonded together. For example, the two ends may be bonded by an ultrasonic weld. Also, at least a portion of the foam core may be adhered to at least a portion of the nonwoven securing layer.

### FIELD OF THE INVENTION

The present invention relates to edging for upholstered furniture articles, such as chairs and couches.

### BACKGROUND OF INVENTION

The typical construction of an upholstered furniture article includes a rigid frame, a plurality of springs, a padding material, and a fabric outer covering. The frame provides the overall shape and structural support for the article. The padding material and the springs, in some areas, cushion the frame to provide comfort to users and to protect the frame. The fabric outer covering usually lies over the top of the frame, the springs, and the padding material.

The fabric outer covering provides protection to the rest of the furniture article from dirt and typically has a decorative pattern for aesthetic purposes. In addition to the decorative pattern, the outer covering may include additional decorative features. For example, the outer covering may include welts used to trim the covering or hide seams between panels in the outer covering. Other features include bands, blind stitching, gimp, and decorative tacks.

The rigid frame usually comprises several interconnected members of a rigid material, such as wood. The individual members often define sharp or rigid edges. It is sometimes desirable to soften these edges for comfort or aesthetic purposes. To that end, manufacturers of upholstered furniture articles may use “edging.” In general, edging, as used in the upholstered furniture industry, is a strip of material applied to an edge of the frame in order to cushion or soften that edge, when the fabric outer covering is placed over the edging. Traditionally, edging was made with twisted paper or non-woven cloth encapsulated by an outer cloth layer. More recently, edging has been provided by extruding a foam polyethylene rod with a lip.

The lip is generally used to attach the foam polyethylene rod near or on the edge of the frame. For example, the lip may be stapled to the frame. However, stapling through the foam polyethylene makes the lip susceptible to tearing and may lead to the shifting or moving of the foam polyethylene rod away from the edge of the frame. Also, the foam polyethylene requires a light pressure from the staple gun or the staples will damage the foam.

### BRIEF SUMMARY OF THE INVENTION

The present invention addresses one or more of the above problems by providing an improved edging strip that includes a foam core and a securing layer that encapsulates the core and provides a tab for attaching the edging strip to a framing element. The securing layer may be a nonwoven cloth material. The nonwoven cloth is stronger and better suited for holding the edging strip to the framing element than the polyethylene lip of prior art edging strips. And the combination of the securing layer and the foam core allows for the maximum use of an inexpensive and abundant material such as foam polyethylene while still utilizing the relatively stronger material of the securing layer.

According to an embodiment of the present invention, the edging strip includes the foam core and the securing layer. The form core may be formed partly or completely from a foam material, such as recycled polyethylene. The securing layer may be formed partly or completely from a nonwoven cloth material. The nonwoven cloth material is wrapped around the foam core such that the foam core is encapsulated by the cloth and the cloth forms a tab for securing the foam core to the framing element. The tab may be defined by a first end and a second end of the cloth that are bonded together. For example, the two ends may be bonded by an ultrasonic weld. Also, at least a portion of the foam core may be adhered to at least a portion of the nonwoven securing layer.

In another embodiment, the present invention provides an upholstered furniture article that includes one or more edging strips. The furniture article includes a framing element and an edging strip. The framing element includes one or more rigid edges. Each edge strip is secured to the framing element such that the edging strip cushions at least a portion of one of the rigid edges. Each edging strip may be secured to the framing element by a plurality of fasteners. For example, a plurality of staples may be driven through the tab and into the framing element in order to secure the edging strip to the framing element.

In yet another embodiment, the present invention provides a method of constructing the upholstered furniture article. The method may include forming the framing element to provide a structural support for the article and securing one or more edging strips to the framing element such that the foam cores of the edging strips lie near or on some or part of the rigid edges of the framing element. The method may further include supporting one or more springs systems to the framing element, laying a padding material over the spring systems and at least part of the frame, and covering the padding material, at least part of the framing element, and the spring system with an outer fabric covering. In addition, the method may include a step of forming the foam cores of the edging strips through an extrusion process with recycled or scrapped polyethylene.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a portion of an edging strip according to an embodiment of the present invention;

FIG. 2 is a cross-section of the edging strip of FIG. 1 taken along line 2-2;

FIG. 3 is a partial cut-out perspective view of an upholstered furniture article according to the present invention; and

FIG. 4 is a partial enlarged cut-out view of the edging strip against a framing element in FIG. 3.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

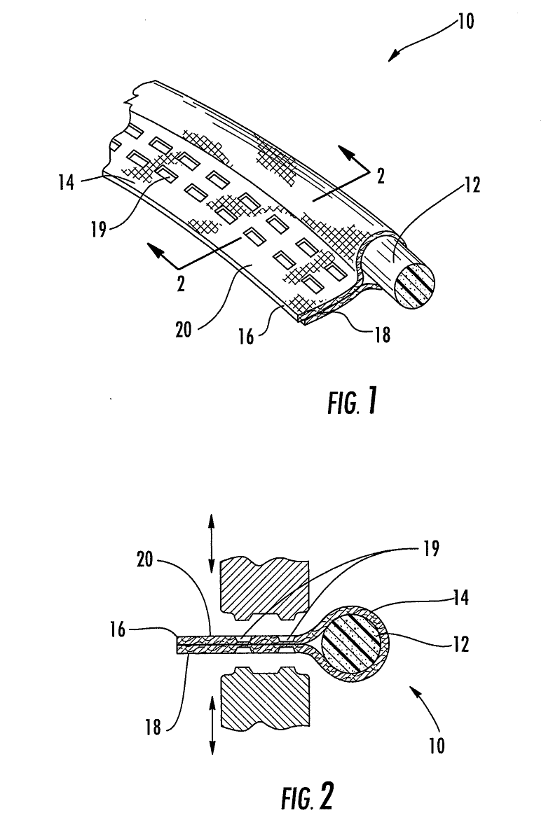

In one aspect the present invention provides an edging strip for cushioning a rigid edge of a framing element in an upholstered furniture article. As shown in FIG. 1, the edging strip 10 includes a foam core 12 and a securing layer 14.

At least a portion of the foam core is formed from a foam material, such as foam polyethylene. For example, the core may be made from an extrusion process using scrapped or recycled polyethylene. The illustrated foam core has a circular cross-section and can be of varying lengths. Also, according to one embodiment of the present invention, the density of the foam material is approximately two to four pounds per cubic foot. However, the density and the overall shape of the foam core may vary in order to adequately soften or cushion at least a portion of a rigid edge of the framing element as further explained below.

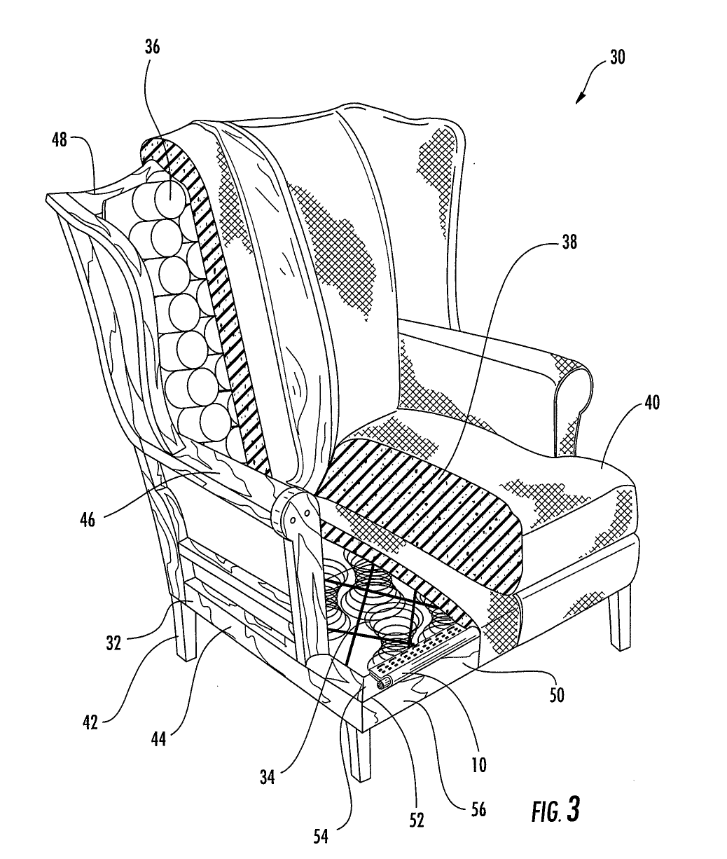

The securing layer is formed from a cloth material. For example, the securing layer may be a nonwoven cloth material. As illustrated in FIG. 1, the securing layer 14 is wrapped around the foam core 12. More specifically, the securing layer 14 is wide enough that the layer 14 may wrap around the foam core 12 and have a first end 16 and second end 18 of the layer extend away from the foam core 12 and define a tab 20. The tab may be held together by bonding the first end 16 and second end 18 together. For example, the cloth material may have a thermoplastic content, such as polyethylene, polypropylene, or polyethylene terephthalate, and the two ends 16, 18 may be bonded together by one or more ultrasonic welds 19, as illustrated in FIG. 2. Other examples include, but are not limited to, the use of an adhesive or a fastener, such as staple, to hold the first end and second end together. The foam core may be free to slide relative to the layer or at least a portion of the core may be adhered to the layer for fixing, such as by gluing or thermally fusing, the foam core within the layer.

In another aspect, the present invention provides an upholstered furniture article that includes at least one edging strip as described above. As shown in the illustrated embodiment of FIG. 3, the upholstered furniture article 30 may be a chair. However, a chair is only an example of the numerous articles within the scope of this invention. For example purposes only, and not as a limitation, the upholstered furniture article of the present invention may be a sofa, a bed, or an ottoman.

According to the illustrated embodiment, the upholstered furniture article 30 includes a frame 32, a seat spring system 34, a back spring system 36, a padding material 38, and a fabric outer covering 40. The frame 32 provides the structural support to the furniture article 30. The spring systems 34, 36 support a seat and back area of the chair. The padding material 38 lays over the spring systems 34, 36 and other areas of the frame 32 to cushion the furniture article 30 and provide some protection to the frame 32. And the fabric outer covering 40 covers most of the furniture article 30 and may include one or more aesthetic features.

The frame 32 includes a number of interconnected elements. The elements may include leg supports 42, a seat box 44, arms 46, and a back 48. Each element is made from a rigid material, such as wood. And one or more elements may have a rigid edge. For example and as illustrated, the seat box 44 includes a front horizontal member 50 with a top front rigid edge 52. Specifically, the top front rigid edge 52 is created by the intersection of the top surface 54 and the front surface 56 of the horizontal member 50. Due to its location and its rigidity, this edge 52 may be a source of discomfort for someone sitting in the chair even with the padding material 38.

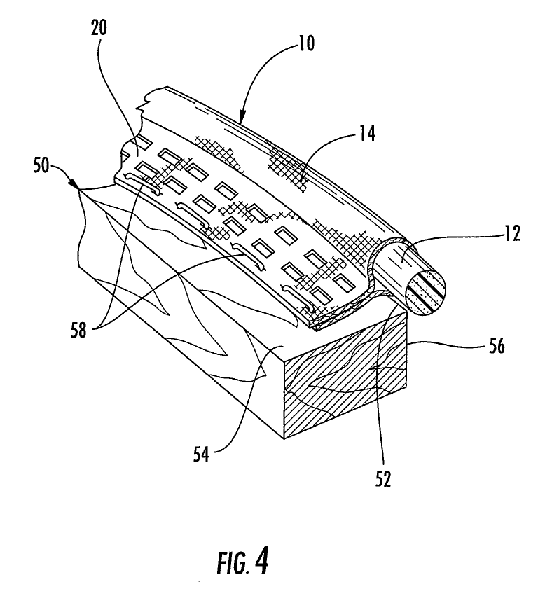

As best seen in FIG. 4, an edging strip 10 may be positioned such that the foam core 12 of the edging strip lies near or on at least a portion of the rigid edge 52 for cushioning the rigid edge 52 and providing comfort for the person sitting in the chair. A number of fasteners 58, such as staples or nails, may be driven through the tab 20 of the edging strip and into the top surface 54 of the horizontal member to position and hold the foam core 12 in place relative to the rigid edge 52. Similarly, additional edging strips may be used to soften rigid edges on the arms or along the back of the chair. Other than cushioning a rigid edge, an edging strip may be positioned near or on a rigid edge in order to alter the outward appearance of the edge for aesthetic purposes. For example, the edging strip may be used to provide a more curved outward appearance for an edge of a framing element. As used herein and the appended claims, “softening” an edge includes one or more of the following: cushioning the edge for comfort or altering the outward appearance of the edge for aesthetic purposes.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An edging strip for softening a rigid edge of a framing element in an upholstered furniture article, the edging strip comprising:
a core formed at least in part from a foam material; and
a securing layer formed at least in part from a nonwoven material, the securing layer being wrapped around the core and defining a tab for securing the core to the framing element such that at least a portion of the core is proximate the rigid edge.

2. The edging strip according to claim 1, wherein the securing layer includes a first end and a second end, the first end and the second end extend along a length of the core and are bonded together to define the tab for securing the edging strip to the framing element.

3. The edging strip according to claim 2, wherein the securing layer has a thermoplastic content.

4. The edging strip according to claim 3, wherein the first end and the second end are bonded by at least one ultrasonic weld.

5. The edging strip according to claim 1, wherein at least a portion of the core is adhered to at least a portion of the securing layer.

6. The edging strip according to claim 1, wherein the foam material is a foam polyethylene.

7. The edging strip according to claim 6, wherein the foam polyethylene is extruded.

8. The edging strip according to claim 6, wherein the foam material is made from recycled polyethylene.

9. An upholstered furniture article comprising:
a framing element having at least one rigid edge; and
an edging strip that is secured to the framing element such that the edging strip softens at least a portion of a rigid edge, the edging strip including;
a core formed at least in part from a foam material; and
a securing layer formed at least in part from a nonwoven material, the securing layer being wrapped around the core and defining a tab for securing the core to the framing element such that at least a portion of the core is proximate the rigid edge.

10. The upholstered furniture article according to claim 9, wherein the tab is secured to the framing element by at least one fastener.

11. The upholstered furniture article according to claim 10, wherein the at least one fastener is a staple.

12. The upholstered furniture article according to claim 9, wherein the securing layer includes a first end and a second end, the first end and the second end extend along a length of the core and are bonded together to define the tab for securing the edging strip to the framing element.

13. The upholstered furniture article according to claim 12, wherein the securing layer has a thermoplastic content.

14. The upholstered furniture article according to claim 13, wherein the first end and the second end are bonded by at least one ultrasonic weld.

15. The upholstered furniture article according to claim 9, wherein at least a portion of the core is adhered to at least a portion of the securing layer.

16. The upholstered furniture article according to claim 9, wherein the foam material is a foam polyethylene.

17. The upholstered furniture article according to claim 17, wherein the foam polyethylene is extruded.

18. The upholstered furniture article according to claim 17, wherein the foam material is made from recycled polyethylene.

19. A method of constructing an upholstered furniture article, the method comprising:
forming a framing element to provide structural support for the furniture article, wherein the framing element has at least one rigid edge; and
securing at least one edging strip to the framing element such that the at least one edging strip lies near at least a portion of a rigid edge, wherein each edging strip includes a core and a securing layer, the core being formed at least in part from a foam material and the securing layer being formed at least in part from a nonwoven material, and the securing layer being wrapped around the core and defining a tab for securing the edging strip to the framing element.

20. The method of claim 19 further comprising covering the at least one edging strip with an outer fabric covering.

21. The method of claim 19 further comprising supporting at least one spring system to the framing element, laying a padding material over at least one portion of the framing element and the at least one spring system, and covering the padding material, the at least one portion of the framing element and the at least one spring system with an outer fabric covering.

22. The method of claim 19, wherein the step of securing at least one edging to the framing element includes driving a plurality of fasteners through the tab and into the framing element.

23. The method of claim 19 further comprising a step of constructing the at least one edging strip by forming the core through an extrusion process using the foam material and wrapping the securing layer around the core and defining the tab.
